(19) United States
(12) Patent Application Publication
(10) Pub. No.: US 2018/0167725 A1
(43) Pub. Date: Jun. 14, 2018

(54) APPARATUS AND METHOD FOR PROVIDING PHONE CALL IN A VEHICLE

(71) Applicant: INFOBANK CORP., Seongnam-si (KR)

(72) Inventors: Ji Sung KIM, Seoul (KR); Sang Gyeong BAE, Gwangmyeong-si (KR); Kwang Rim HA, Seoul (KR); Chang Seok YOUK, Bucheon-si (KR)

(21) Appl. No.: 15/836,445

(22) Filed: Dec. 8, 2017

(30) Foreign Application Priority Data
Dec. 8, 2016 (KR) 10-2016-0166802

(51) Int. Cl. H04R 1/32; H04R 3/00; G10L 21/0208

(52) U.S. Cl. CPC H04R 1/323; H04R 2499/13; G10L 21/0208; H04R 3/00

(57) ABSTRACT

The method for providing phone call in a vehicle according to an embodiment of the present invention may include steps of providing first sound signal in which phone call sound is beam formed to be audible only to first occupant, by controlling first directional speaker, when phone call request for the first occupant in the vehicle is received; and providing second sound signal different from the first sound signal which is beam formed to be audible to second occupant, by controlling second directional speaker, while the first phone call sound is provided.

### CROSS-REFERENCE TO RELATED APPLICATIONS

This application claims priority to Korean patent application No. 10-2016-0166802 filed on Dec. 8, 2016, the entire content of which is hereby incorporated by reference.

### FIELD OF THE DISCLOSURE

The present invention relates to an apparatus and a method for providing phone call in a vehicle.

### BACKGROUND OF THE DISCLOSURE

With development of communications technology and voice processing technology, many improvements have been realized also in hands-free system for providing free phone call of driver or occupant in a vehicle regardless of driving of vehicle.

For the above, hands-free system for vehicle may collect voice of driver via microphone installed in the vehicle, may transmit to telephone line, and may output voice signal of outer person over the phone via speaker in the vehicle or wired/wireless earphone or the like, for facilitating telephone conversation while driver is driving.

However, in a vehicle, not only voice of driver, but also unnecessary sound to the hands-free system may exist such as engine sound or car audio sound or the like. Therefore, it is disclosed in prior document of laid-public patent gazette KR10-2015-0047981 or the like that beam forming microphone is used for minimizing influence of surrounding noise or interfering sound etc. using multiple microphones, for microphone adapted in hands-free system and attached inside of the vehicle.

However, in case that voice is outputted into inside of vehicle using interior speaker, on the contrary, there is a problem that received voice of outside person over the phone may become an unnecessary sound to other occupants excluding a person on the phone in the vehicle.

For example, it may be a problem that, when interesting news or music, film or the like was being played before getting the phone, occupants except the person on the phone should feel being stopped off or should to listen to unwanted phone voice by answering the phone. And, in case of occupant who was staying calm without any sound, it may be a problem that he should listen to unwanted bell sound or voice.

Especially, in case that the person currently on the phone is not the driver, because of this unnecessary sound, a problem may arise that the driver may not be able to concentrate on navigation system or the like, which may become a factor to disturb safe driving.

### SUMMARY

### Technical Problem

The present invention is to settle the above described problem, of which an object is to provide an apparatus and a method for providing phone call in a vehicle, in which beam forming based directional speaker toward occupant is provided, and during hands-free phone call in the vehicle, by outputting hands-free voice only to person on the phone, while outputting sound signal for cancelling the hands-free voice to other occupants, enabling hands-free phone call without disturbing listening of other occupants and improving convenience via providing additional information.

### Technical Solution

A method for providing phone call in a vehicle according to an embodiment of the present invention to settle the above problem may include, in a method for providing phone call in a vehicle, steps of providing first sound signal in which phone call sound is beam formed to be audible only to first occupant, by controlling first directional speaker, when phone call request for the first occupant in the vehicle is received; and providing second sound signal different from the first sound signal, which is beam formed to be audible to second occupant, by controlling second directional speaker, while the first phone call sound is provided.

And, an apparatus for providing phone call in a vehicle according to an embodiment of the present invention to solve the above problem may include a first directional speaker control unit for providing first sound signal in which first phone call sound is beam formed to be audible only to first occupant, by controlling first directional speaker, when phone call request for first occupant in the vehicle is received; and a second directional speaker control unit for providing second sound signal different from the first sound signal, which is beam formed to be audible to second occupant, by controlling second directional speaker, while the first phone call sound is provided.

On the other hand, the method according to an embodiment of the present invention to settle the above problem may be realized as a computer readable recording medium in which a program is recorded for implementing the method on a computer and a program thereof.

### Advantageous Effects

According to an embodiment of the present invention, an apparatus and a method for providing phone call in a vehicle may be provided in which beam forming based directional speaker toward occupant is provided, and during hands-free phone call in the vehicle, by outputting hands-free voice only to person on the phone, while outputting sound signal for cancelling the hands-free voice to other occupants, by which facilitate hands-free phone call without disturbing listening of other occupants and improving convenience via providing additional information may be enabled.

### BRIEF DESCRIPTION OF DRAWINGS

FIG. 1 is a block diagram for explanation of apparatus for providing phone call in a vehicle according to an embodiment of the present invention.

FIG. 2 is a drawing for specific explanation of beam forming way according to an embodiment of the present invention.

FIG. 3 is a flow chart for explanation of method for providing phone call in a vehicle according to an embodiment of the present invention.

FIG. 4 is a drawing for explanation of providing phone call in a vehicle and interface according to the same according to an embodiment of the present invention.

### DETAILED DESCRIPTION

The present invention may be applied with variety of modification and may have variety of embodiments, and may be illustrated in drawings by specific embodiments and be described in detail in specification.

This is not to limit the present invention to a specific embodiment, but the present invention may be understood as to include all the modifications, equivalences to substitutes included in the scope of idea and technology of the present invention. In description of the present invention, terms like first, second, or the like may be used in explanation of a variety of components, though the components may not be limited to the terms. The terms should be used only for distinguishing one component from another component. For example, without escape from scope of claims of the present invention, first component may be called as second component, while likewise, second component may be called as first component.

In case that a component is said to be “connected” or “contacted” to another component, it may be directly connected or contacted to the other component, while may be understood as further another component can exist therebetween. On the other hand, a component is said to be “directly connected” or “directly contacted” to another component, further another component therebetween may be understood as not to exist.

Terms used in the specification is used only for explanation of specific embodiment, and is not intended to limit the present invention. Singular expression may include plural expression unless explicitly expressed otherwise by context. Terms like “include” or “have” in the specification are to indicate existence of features, numbers, steps, operations, components, elements or combinations thereof written in the specification, and may be understood as not to exclude beforehand possibility of existence or addition of one or more other features, numbers, steps, operations, components, parts or combinations thereof. Unless defined otherwise, all the terms used herein including technological or scientific terms may have the same meaning as that generally understood by an ordinary skilled person in the art field in which the present invention pertains.

Terms such as those defined in generally used dictionary may be interpreted as to have identical meaning to the meaning of context of related technology, and unless explicitly defined in the present invention, may not be interpreted in ideal or excessively formal meaning. And, embodiments below are provided for more complete explanation to an ordinary skilled person in the art, of which shape and size and the like of components in drawings may be exaggerated for the sake of clearer explanation.

And, for example, block diagrams of the specification should be understood as to represent conceptual view point of example circuit for actualization of principle of the present invention. Functions of a variety of elements depicted in drawings including functional block representing processor or similar concept thereof may be provided using not only exclusive hardware but also any hardware having faculty of running software in relation to a proper software. When provided by processor, the function may be provided by single exclusive processor, single shared processor, or a plurality of separate processors, among which some may be shared. And, explicit use of terms presented as a concept of processor, control, or the like should not be interpreted exclusively citing hardware having ability to implement software, but should be understood to include implicitly digital signal process (DSP) hardware, ROM, RAM and non-volatile memory for storage of software without limitation. Well known or publicly known other hardware may be included.

In claims of the present specification, components expressed as means for implementing function written in detailed description are intended to include all the methods performing function including software of all the type including, for example, combination of circuit element, or firmware/micro code for performing the function, and may be combined to proper circuit for implementing the software to perform the function. Since the present invention defined by the claims may be combined with functions provided by a variety of enumerated means and may be combined with ways requested by claim, any means capable of providing the function should be understood as to be equivalent to one understood from the present specification.

Hereinafter, a preferred embodiment according to the present invention will be described in detail with reference to attached drawings.

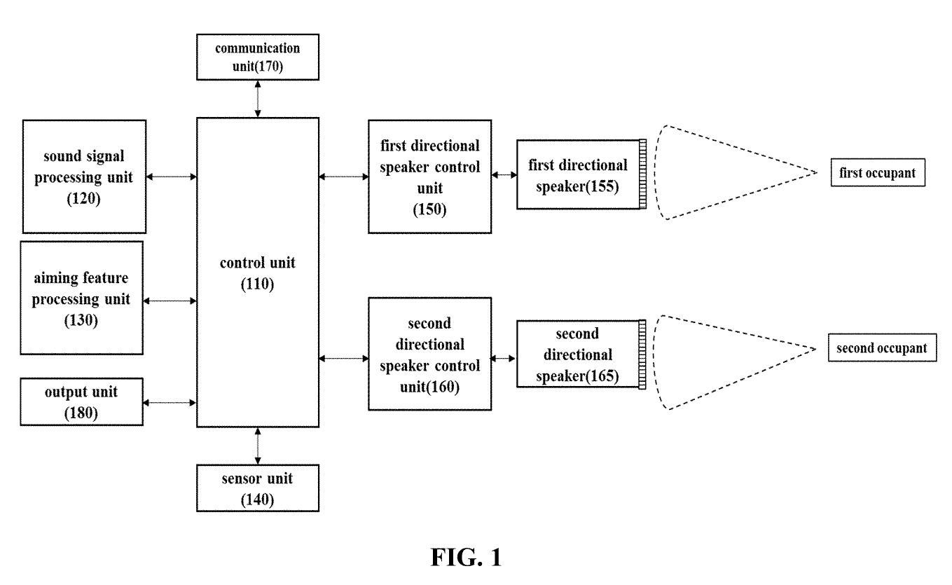

An apparatus for providing phone call in a vehicle 100 according to an embodiment of the present invention in FIG. 1 may include control unit 110, sound signal processing unit 120, aiming feature processing unit 130, sensor unit 140, first directional speaker control unit 150, second directional speaker control unit 160, communication unit 170 and output unit 180. First, the control unit 110 can control a plurality of electric elements provided for vehicle driving according to user operating input through one or more vehicle control means.

And, the control unit 110 may include one or more processor for providing function of providing phone call in a vehicle according to an embodiment of the present invention. Control of sound signal processing and directional speaker according to an embodiment of the present invention may be performed generally via operation of each elements according to control of the control unit 110, of which result may be outputted.

Especially, for the above, when phone call request for the first occupant in the vehicle is received, the control unit 110 may process first sound signal including first phone call sound to be provided to first occupant via the sound signal processing unit 120, and may add aiming feature information to the first sound signal via the aiming feature processing unit 130.

As above, the first sound signal processed with phone call sound information and aiming feature information may be provided to the first directional speaker control unit 150, and the first directional speaker control unit 150 may provide first sound signal beam formed as to be audible only to the first occupant to a direction of the first occupant according to the aiming feature information.

For the above, the first directional speaker control unit 150 may output the sound signal beam formed to a predetermined angle or direction of the first occupant direction via control of array output of the first directional speaker 155.

On the other hand, the control unit 110 may process, while the first phone call sound is provided according to the phone call process, the second sound signal to be provided to second occupant via the sound signal processing unit 120, and may add aiming feature information to the second sound signal via the aiming feature processing unit 130.

Accordingly, the second directional speaker control unit 160 may control the second directional speaker while the first phone call sound is provided, and may provide the second sound signal to the second occupant which is beam formed as to be audible to the second occupant and different from the first phone call sound.

For above, the second directional speaker control unit 160 may output sound signal beam formed to predetermined angle or direction of the second occupant direction via control of array output of the first directional speaker 165.

And, in an embodiment of the present invention, the sound signal processing unit 120 may perform mixing processing of sound sources provided through the first directional speaker control unit 150 and the second directional speaker control unit 160.

More specifically, the sound signal processing unit 120 may generate cancellation sound signal capable of cancelling the first phone call sound at position of the second occupant based on the first phone call sound, and may mix the cancellation sound signal and predetermined second sound signal.

Accordingly, the second directional speaker control unit 160 may control the audio beam forming of the second directional speaker 165 so that the mixed sound signal is directed to the second occupant.

And, in the case that a preexisting sound signal outputted before receipt of the phone call request by the first sound signal, the sound signal processing unit 120 may mix the second sound signal and the preexisting sound signal.

And, in mixing, relative position information of the second occupant with respect to the first occupant may be considered. For the above, the sensor unit 140 may sense position information of the first occupant to whom the first sound signal including the first phone call sound is to be provided, and may sense position of the second occupant to whom the second sound signal is to be provided, and the sensed information may be delivered to the signal processing unit 120 and the aiming feature processing unit 130 via the control unit 110.

Accordingly, the sound signal processing unit 120 may calculate balancing information corresponding to the position of the second occupant with reference to the position information of the first occupant, and accordingly, by mixing the second sound signal and the preexisting sound signal in proper ratio, may attain effect of cancelling the first phone call sound while keeping the state that the preexisting sound is listened as it was.

And, the sound signal processing unit 120 may process, in case that there do not exist the preexisting output sound signal, a guidance voice message representing that the first occupant is on the phone into the second sound signal according to the balancing information corresponding to the position of the second occupant.

As above, the second sound signal may be changeable immediately by choice of user or setting of interface. For example, the second sound signal may include voice or melody information representing that the first occupant is on the phone. And, in case that the second occupant wants to listen to the phone call sound also, the first sound signal may of course be provided to the second occupant.

On the other hand, the communication unit 170 may include one or more communication module for sending and receiving phone call information or sound source information. Here, the communication module may be illustrated as modules of a variety of wireless communication way such as near communication module such as WiFi method, Bluetooth method, or NFC method, or mobile communication module.

And, the output unit 180 may include one or more output module for outputting vehicle interface. Here, the output module may have a shape of vehicle display, or shape of wired/wireless communication module for outputting the vehicle interface through display of another terminal.

And, in an embodiment of the present invention, the output unit 180 may provide vehicle interface to receive setting information of while the first phone call sound according to an embodiment of the present invention is being provided, and may include display unit for outputting the first sound signal providing information of the first directional speaker, and the second sound signal providing information of the second directional speaker, respectively, onto the vehicle interface, while the first phone call sound is provided.

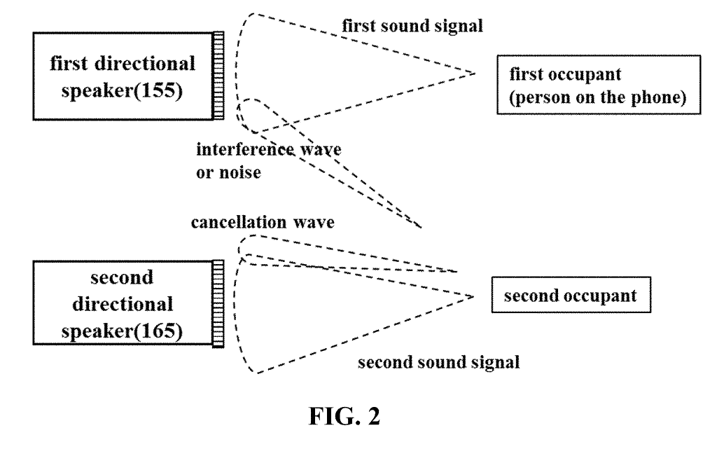

FIG. 2 is a diagram for more specific explanation of beam forming way according to an embodiment of the present invention.

According to an embodiment of the present invention, the beam forming technique for forming beam in a specific direction may be described as a similar way to a process for beam forming using micro phone array. Accordingly, each of the first directional speaker 155 and the second directional speaker 165 may include speaker array including a plurality of speaker elements.

And, to apply directional nature of sound, each of speakers 155 and 165 may output sound beam in each of beam forming direction according to aiming feature, by controlling the first directional speaker control unit 150 and the second directional speaker control unit 160 according to beam forming way.

Here, the way of beam output may be classified to fixed beam forming and adaptive beam forming according to usage of output information. A representative example of the fixed beam forming is DSB (Delay and Sum Beam forming), and a way may be illustrated in which time delay of output signals by each channel may be compensated, and phase matching with respect to objective direction. And, besides, there is LMS (Least Mean Square) way and Dolph-Chebyshev way. And, the adaptive beam forming may be designed so that weight value of beam former may be changed according to signal environment. As representative adaptive beam forming way, there exist GSC (Generalized Side-lobe Canceller) and LCMV (Linearly Constrained Minimum Variance) ways.

Only, even though implemented by the way above, since the first occupant and the second occupant are existing in the same interior, interference wave or noise or the like due to the first sound signal may be delivered to the second occupant. Therefore, according to an embodiment of the present invention, the sound signal processing unit 120 may mix additional wave capable of cancelling the interference wave and noise signal to the output of the second directional speaker control unit 160 when generating the second sound signal.

Accordingly, the second occupant may be secured to sound source of preexisting listening or silent environment, in a state that interference or noise due to the first sound signal is minimized.

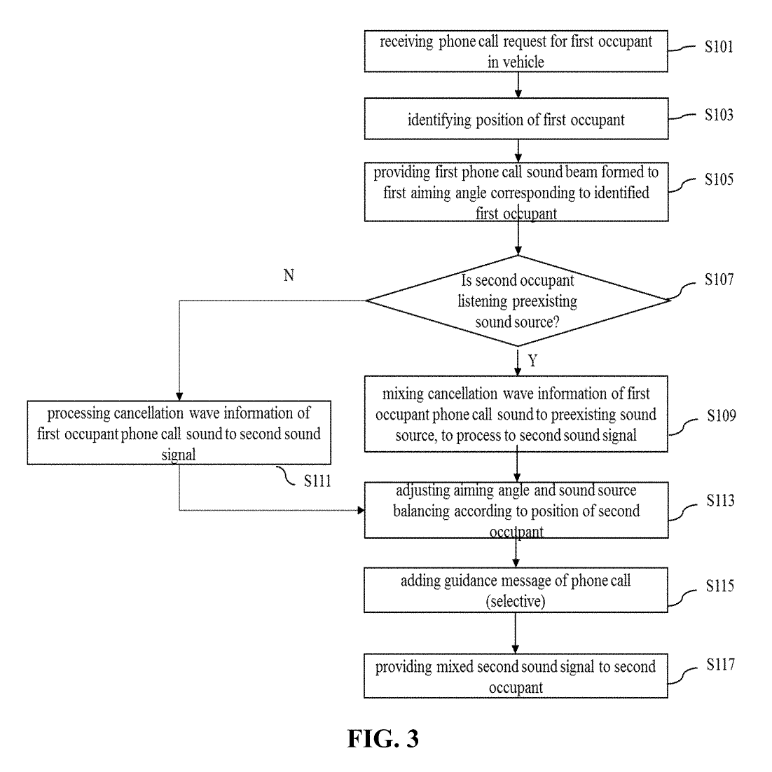

FIG. 3 is a flow chart for explanation of method for providing phone call in a vehicle according to an embodiment of the present invention.

Referring to FIG. 3, first, the apparatus for providing phone call in a vehicle 100 may receive phone call request with respect to the first occupant in the vehicle through communication unit 170 (S101).

And, the apparatus for providing phone call in the vehicle 100 may identify position of the first occupant to receive phone call via the sensor unit 140 (S103).

And, the apparatus for providing phone call in the vehicle 100 may form the first phone call sound beam formed corresponding to first aiming angle corresponding to the first occupant through the aiming feature processing unit 130 and the sound signal processing unit 120, to provide the phone call sound beam formed above to the first occupant via the first directional speaker control unit 150 (S105).

And, the apparatus for providing phone call in the vehicle 100 may judge whether the second occupant is listening to a preexisting sound source via the control unit 110 (S107).

Here, in case of preexisting sound source, it may include information of, for example, audio sound source for other video, sound source of radio, or sound source corresponding to music being listened to.

In case that preexisting sound source is being listened to, the apparatus for providing phone call in the vehicle 100 may mix cancellation wave information for first phone call sound received by the first occupant to the preexisting sound source, via the sound signal processing unit 120, to process the second sound signal (S109).

On the other hand, in case that no preexisting sound source being listened to exist, the apparatus for providing phone call in the vehicle 100 may process cancellation wave information of first occupant phone call sound to the second sound signal via the sound signal processing unit 120 (S111).

And, the apparatus for providing phone call in a vehicle 100 may add aiming angle information corresponding to the second occupant position to the second sound signal via the aiming feature processing unit 130, and the sound signal processing unit 120 may control properly balancing between sound sources according to aiming feature (S113).

Here, control of balancing may be performed by a variety of ways, and predetermined balancing value by each position may be used representatively.

For example, information of occupant position may be identified as driver seat, passenger seat, rear center, right or left side or the like, and sensing of information of each of occupant position may be performed by proximity sensor or gravity sensor located at seat.

Accordingly, relative position information of aiming angle within a predetermined range by each seat may be stored in the apparatus for providing phone call in the vehicle 100 in advance, and accordingly balancing adjustment between cancellation wave of the first occupant phone call sound and preexisting sound source or no sound may be performed.

On the other hand, the apparatus for providing phone call in the vehicle 100 may selectively add a phone call guidance message representing that the first occupant is on the phone to the second sound signal via the sound signal processing unit 120 (S115).

After then, the apparatus for providing phone call in the vehicle 100 may provide the mixed and aiming processed second sound signal to the second occupant via the second directional speaker control unit 160 (S117).

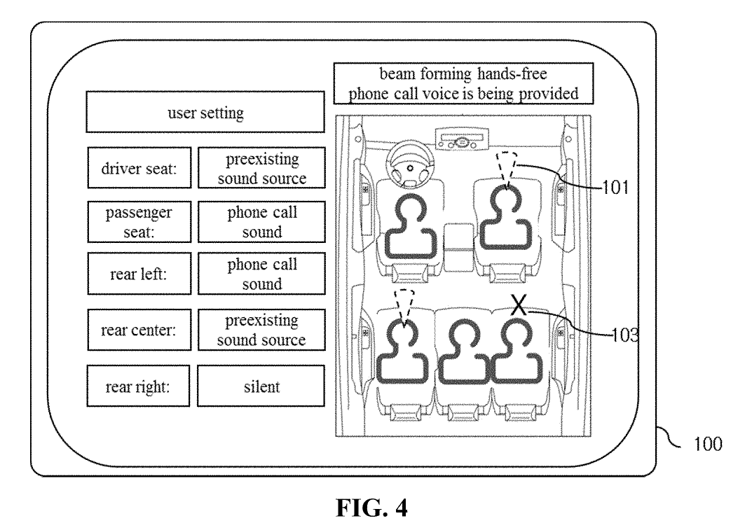

FIG. 4 is a drawing for explanation of providing phone call in a vehicle according to an embodiment of the present invention and interface according to the same.

Referring to FIG. 4, apparatus for providing phone call in the vehicle 100 according to an embodiment of the present invention may provide beam forming status information corresponding to providing phone call in a vehicle according to an embodiment of the present invention and setting interface for the same.

As shown in FIG. 4, the apparatus for providing phone call in the vehicle 100 may display status information of providing current beam forming hands-free phone call voice on the vehicle interface. For example, status information of beam forming of the first sound signal including phone call voice may be displayed in a form added with beam forming icon 101 by each seat, and in case that preexisting sound source is continued to be listened to, in status information of beam forming of the second sound signal may be displayed in a form without other display. And, in case that the second sound signal is silent, silent icon 103 may be displayed together.

And, user setting interface for controlling beam forming above may be outputted on the display of the apparatus for providing phone call in the vehicle 100 together. For example, occupant position possible to be sensed may be identified as driver seat, passenger seat, rear left, center, right or the like as above, and interface capable of setting whether being provided with the first sound signal (phone call voice) or being provided with canceled second sound signal (preexisting sound source or silent) for each seat may be outputted via apparatus for providing phone call in the vehicle 100.

According to an embodiment of the present invention as above, with providing occupant directional speaker based on beam forming, when hands-free phone call in vehicle, by outputting hands-free voice only to person on the phone, while outputting sound signal cancelling the hands-free voice to other occupants, by which apparatus and method for providing phone call in the vehicle may be provided which may not disturb listening of other occupant, may enable hands-free phone call, and may improve convenience thereof via providing additional information.

The method according to the present invention above may be produced as a program for being implemented on a computer, may be stored in a computer readable recording medium, wherein examples of computer readable recording medium may be ROM, RAM, CD-ROM, magnetic tape, floppy disk, light data storage apparatus or the like.

The computer readable recording medium may be distributed over computer system connected by network, and computer readable code may be stored and implemented in a distributed way. And, functional program, code, and code segments for realizing the method may be inferred with ease by programmers in the technical field in which the present invention pertains.

And, though preferable embodiments of the present invention have been depicted and described above, the present invention may not be limited to specific embodiments above, but a variety of modified implementation may be of course possible, by an ordinary skilled person in the art where the present invention pertains, without escaping from gist of the present invention claimed in the claims, and these modified implements should not be understood as to separate from technical idea or perspective of the present invention.

What is claimed is:

1. A method for providing phone call in a vehicle comprising steps of
providing first sound signal in which phone call sound being beam formed to be audible only to first occupant, by controlling first directional speaker, when phone call request for the first occupant in the vehicle being received; and
providing second sound signal different from the first sound signal, which being beam formed to be audible to second occupant, by controlling second directional speaker, while the first phone call sound being provided.

2. The method for providing phone call in a vehicle according to claim 1, wherein the step of providing the second sound signal comprising steps of
mixing the second sound signal and a preexisting sound signal, in case that there existing the preexisting sound signal outputted before reception of the phone call request; and
controlling audio beam forming of the second directional speaker so that the mixed sound signal being directed to the second occupant.

3. The method for providing phone call in a vehicle according to claim 2, wherein the step of mixing comprising steps of
sensing position of the second occupant; and
mixing the second sound signal and the preexisting sound signal, according to balancing information corresponding to the position of the second occupant.

4. The method for providing phone call in a vehicle according to claim 2, further comprising step of
processing guidance voice message representing that the first occupant being on the phone into the second sound signal, according to balancing information corresponding to the position of the second occupant, in case that the preexisting output sound signal being not existing.

5. The method for providing phone call in a vehicle according to claim 1, wherein the step of providing the second sound signal further comprising steps of
generating cancellation sound signal capable of cancelling the first phone call sound, based on the first phone call sound;
mixing the cancellation sound signal and predetermined second sound signal; and
controlling audio beam forming of the second directional speaker so that the mixed sound signal being directed to the second occupant.

6. The method for providing phone call in a vehicle according to claim 1, wherein the second sound signal comprising voice or melody information representing that the first occupant being on the phone.

7. The method for providing phone call in a vehicle according to claim 1, further comprising steps of
displaying a vehicle interface; and
outputting first sound signal providing information of the first directional speaker, and second sound signal providing information of the second directional speaker on the vehicle interface respectively, while the first phone call sound being provided.

8. An apparatus for providing phone call in a vehicle comprising
a first directional speaker control unit for providing first sound signal in which first phone call sound being beam formed to be audible only to first occupant, by controlling first directional speaker, when phone call request for the first occupant in the vehicle being received; and
a second directional speaker control unit for providing second sound signal different from the first sound signal, which being beam formed to be audible to second occupant, by controlling second directional speaker, while the first phone call sound being provided.

9. The apparatus for providing phone call in a vehicle according to claim 8 further comprising sound signal processing unit for mixing the second sound signal and a preexisting sound signal, in case that there being preexisting sound signal outputted before receipt of the phone call request, wherein
the second directional speaker control unit controlling audio beam forming of the second directional speaker, so that the mixed sound signal being directed to the second occupant.

10. The apparatus for providing phone call in a vehicle according to claim 9 further comprising a sensing unit for sensing position of the second occupant, wherein
the sound signal processing unit mixing the second sound signal and the preexisting sound signal, according to balancing information corresponding to the position of the second occupant.

11. The apparatus for providing phone call in a vehicle according to claim 9 wherein
the sound signal processing unit processing guidance voice message representing that the first occupant being on the phone into the second sound signal, according to balancing information corresponding to the position of the second occupant, in case that the preexisting output sound signal being not existing.

12. The apparatus for providing phone call in a vehicle according to claim 8 wherein
the sound signal processing unit generating cancellation sound signal capable of cancelling the first phone call sound based on the first phone call sound, and mixing the cancellation sound signal and predetermined second sound signal, and
the second directional speaker control unit controlling audio beam forming of the second directional speaker, so that the mixed sound signal being directed to the second occupant.

13. The apparatus for providing phone call in a vehicle according to claim 8 wherein
the second sound signal comprising voice or melody information representing that the first occupant being on the phone.

14. The apparatus for providing phone call in a vehicle according to claim 8 further comprising a display unit for displaying vehicle interface,
wherein the display unit outputting first sound signal providing status information of the first directional speaker and second sound signal providing status information of the second directional speaker respectively on the vehicle interface, while the first phone call sound is provided.

15. A computer readable recording medium in which program being recorded for implementing method written on claim 1 on a computer.
